(19) United States
(12) Patent Application Publication
(10) Pub. No.: US 2026/0122744 A1
(43) Pub. Date: Apr. 30, 2026

(54) LED SHORT DETECTION CIRCUIT AND LED SYSTEM INCLUDING THE SAME

(71) Applicant: Samsung Electro-Mechanics Co., Ltd., Suwon-si (KR)

(72) Inventor: Jeong Hyun PARK, Suwon-si (KR)

(73) Assignee: Samsung Electro-Mechanics Co., Ltd., Suwon-si (KR)

(21) Appl. No.: 19/288,601

(22) Filed: Aug. 1, 2025

(30) Foreign Application Priority Data
Oct. 31, 2024 (KR) 10-2024-0152385
Mar. 24, 2025 (KR) 10-2025-0037293

(51) Int. Cl. H05B 45/54; H05B 45/325; H05B 45/34; H05B 47/23

(52) U.S. Cl. CPC H05B 45/54; H05B 45/325; H05B 45/34; H05B 47/23

(57) ABSTRACT

A light-emitting diode (LED) short detection circuit includes a first smoothing circuit configured to receive a first LED driving voltage applied to a first end of an LED string and perform smoothing on the first LED driving voltage; a second smoothing circuit configured to receive a second LED driving voltage applied to a second end of the LED string and perform smoothing on the second LED driving voltage; an amplifier configured to amplify a difference between a first smoothing voltage output from the first smoothing circuit and a second smoothing voltage output from the second smoothing circuit to output a detection voltage; and a short-circuit determination circuit configured to compare the detection voltage with a predetermined reference voltage to output a short-circuit signal indicating whether a short-circuit has occurred.

### CROSS-REFERENCE TO RELATED APPLICATIONS

This application claims the benefit under 35 USC 119(a) of Korean Patent Application Nos. 10-2024-0152385 filed on Oct. 31, 2024, and 10-2025-0037293 filed on Mar. 24, 2025, with the Korean Intellectual Property Office, the entire disclosures of which are incorporated herein by reference for all purposes.

### BACKGROUND

### 1. Field

The present disclosure relates to an LED short detection circuit and an LED system including the same.

### 2. Description of the Background

A light-emitting diode (LED) is a semiconductor device that emits light when a current is applied. LEDs are used for a variety of purposes, including lighting and backlighting of displays, and recently, LEDs are also being used in battlefield cameras.

A vehicle-mounted camera is installed inside a vehicle and used to monitor a driver, a passenger, etc. An infrared camera is used to monitor drivers and passengers. In an infrared camera, an infrared LED may be used as a light source.

In the infrared LED used as light sources, multiple LEDs are connected in series with each other. A circuit may be desired to detect even when a problem (short circuit) occurs in at least one LED among the LEDs.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a light-emitting diode (LED) short detection circuit includes a first smoothing circuit configured to receive a first LED driving voltage applied to a first end of an LED string and perform smoothing on the first LED driving voltage; a second smoothing circuit configured to receive a second LED driving voltage applied to a second end of the LED string and perform smoothing on the second LED driving voltage; an amplifier configured to amplify a difference between a first smoothing voltage output from the first smoothing circuit and a second smoothing voltage output from the second smoothing circuit to output a detection voltage; and a short-circuit determination circuit configured to compare the detection voltage with a predetermined reference voltage to output a short-circuit signal indicating whether a short-circuit has occurred.

The LED short detection circuit may further include a buffer configured to receive the second smoothing voltage and output the second smoothing voltage to the amplifier.

The first smoothing circuit may include a first resistor having a first end connected to the first end of the LED string, and a first capacitor connected between a second end of the first resistor and ground, and the second smoothing circuit may include a second resistor having a first end connected to the second end of the LED string, and a second capacitor connected between a second end of the second resistor and ground.

The LED short detection circuit may further include a buffer configured to have an input terminal connected to the second end of the second resistor, and an output terminal outputting the second smoothing voltage to the amplifier.

The short-circuit signal may indicate a short circuit in response to the detection voltage being lower than the reference voltage.

The short-circuit determination circuit may include a comparator that receives each of the detection voltage and the reference voltage and outputs the short-circuit signal.

An LED system may include an LED driving circuit configured to supply the first LED driving voltage and the second LED driving voltage, and the LED short detection circuit described herein may be configured to receive the first LED driving voltage and the second LED driving voltage.

In another general aspect, light-emitting diode (LED) includes an LED string configured to include a plurality of LEDs, an LED driving circuit configured to supply a first LED driving voltage to a first end of the LED string and a second LED driving voltage to a second end of the LED string, and an LED short detection circuit configured to receive the first LED driving voltage and the second LED driving voltage and generate a short-circuit signal indicating whether a short-circuit has occurred in the LED string, and the LED short detection circuit may include a first smoothing circuit configured to perform smoothing on the first LED driving voltage to output a first smoothing voltage, a second smoothing circuit configured to perform smoothing on the second LED driving voltage to output a second smoothing voltage, an amplifier configured to amplify a difference between the first smoothing voltage and the second smoothing voltage to output a detection voltage, and a short-circuit determination circuit configured to compare the detected voltage with a predetermined reference voltage to output a short-circuit signal.

The LED short detection circuit may further include a buffer configured to receive the second smoothing voltage and output the second smoothing voltage to the amplifier.

The first smoothing circuit may be an RC smoothing circuit configured to generate the first smoothing voltage corresponding to an average value of the first LED driving voltage, and the second smoothing circuit may be an RC smoothing circuit configured to generate the second smoothing voltage corresponding to an average value of the second LED driving voltage.

The short-circuit signal may indicate a short circuit in response to the detection voltage being lower than the reference voltage.

The short-circuit determination circuit may include a comparator that receives each of the detection voltage and the reference voltage and outputs the short-circuit signal.

Other features and aspects will be apparent from the following detailed description, the drawings, and the claims.

### BRIEF DESCRIPTION OF DRAWINGS

FIG. 1 illustrates an LED system according to an embodiment.

FIG. 2 illustrates a graph exemplifying LED driving voltages V_{LED+} and V_{LED-}, an LED driving current I_{LED}, and on/off states of an LED string 300.

FIG. 3 illustrates a block diagram showing a simple internal configuration of an LED short detection circuit.

FIG. 4 illustrates a circuit diagram showing a detailed internal configuration of an LED short detection circuit.

FIG. 5 illustrates a conceptual graph representing LED driving voltages V_{LED+} and V_{LED-} and smoothing voltages V_{SM+} and V_{SM-}.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

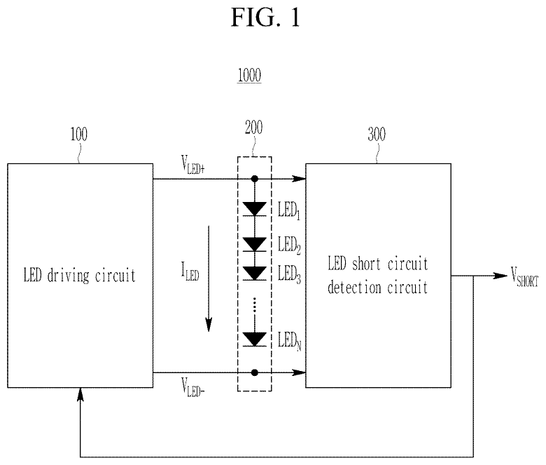

FIG. 1 illustrates an LED system 1000 according to an embodiment.

As shown in FIG. 1, the LED system 1000 may include an LED driving circuit 100, an LED string 200, and an LED circuit detection circuit 300. The LED system 1000 of FIG. 1 may be mounted on a vehicle-mounted camera to emit infrared rays.

The LED driving circuit 100 may generate LED driving voltages V_{LED+} and V_{LED-}, which may then be applied to the LED string 200. The LED driving voltage may include a first LED driving voltage V_{LED+} and a second LED driving voltage V_{LED-}. The first LED driving voltage V_{LED+} may be applied to a first end of the LED string 200, while the second LED driving voltage V_{LED-} may be applied to a second end of the LED string 200.

The LED driving circuit 100 may include a DC (direct current)-DC (direct current) converter (not shown), and the DC-DC converter may be configured to generate and output the LED voltages V_{LED+} and V_{LED-}. As an example, the DC-DC converter may be a boost converter or a buck converter. As an example, the first LED driving voltage V_{LED+} may be a positive (+) voltage, and the second LED driving voltage (V_{LED-}) may be a ground voltage. As another example, the first LED driving voltage V_{LED+} and the second LED driving voltage V_{LED-} may both be positive (+) voltages. A method by which the LED driving circuit 100 generates the LED driving voltage is known to those of ordinary skill in the art of the present embodiment, so a detailed description thereof will be omitted.

The LED string 200 may include multiple LEDs LED₁ to LED_{N}. Herein, N may be a natural number that is greater than or equal to 2. The LEDs LED₁ to LED_{N} may be connected in series with each other. An anode of the first LED LED₁ may be connected to a terminal where the first LED driving voltage V_{LED+} is output, and a cathode of the last LED LED_{N} may be connected to a terminal where the second LED driving voltage V_{LED-} is output. That is, the first LED LED₁ may be a first end of the LED string 200, and the last LED LED_{N} may be a second end of the LED string 200.

A difference between the first LED driving voltage V_{LED+} and the second LED driving voltage V_{LED-} may enable the LEDs LED₁ to LED_{N} to turn on, allowing them to emit light. Herein, the LED driving circuit 100 may not only apply the LED driving voltages V_{LED+} and V_{LED-} to the LED string 200 may but also control a flow of the LED driving current I_{LED} through the LED string 200. As an example, the LED driving current I_{LED} may be a pulse width modulation (PWM) signal.

The LED short detection circuit 300 may receive the two LED driving voltages V_{LED+} and V_{LED-} applied to the LED string 200 as inputs. The LED short detection circuit 300 may generate a short-circuit signal V_{SHORT} using values corresponding to the two LED driving voltages V_{LED+} and V_{LED-}. The short-circuit signal V_{SHORT} generated by the LED short detection circuit 300 may be fed back to the LED driving circuit 100. The short-circuit signal V_{SHORT} may indicate whether at least one LED in the LED string 200 is short-circuited. As an example, if at least one LED in the LED string 200 is short-circuited, the short-circuit signal V_{SHORT} may be at a high level. If no short-circuit occurs in the LED string 200, the short-circuit signal V_{SHORT} may be at a low level.

When the LEDs LED₁ to LED_{N} included in the LED string 200 are turned on, a voltage across the LED string 200, V_{LED+} to V_{LED-}, may be expressed by following Equation 1.

$${V}_{LED +} - {V}_{LED -} = N * {V}_{F} \qquad Equation 1$$

In Equation 1, it is assumed that each of the multiple LEDs LED₁ to LED_{N} has the same turn-on voltage VF.

If no short-circuit occurs in the LED string 200, the voltage across the LED string 200 may correspond to the aforementioned Equation 1.

If a short circuit occurs in one of the multiple LEDs LED₁ to LED_{N}, the voltage across the LED string 200 may become (N−1)*VF. Then, if short circuits occur in two of the multiple LEDs LED₁ to LED_{N}, the voltage across the LED string 200 may become (N−2)*VF. In this way, when a short circuit occurs in the LED string 200, the voltage across the LED string 200 may decrease (drop), and the LED short detection circuit 300 may detect the short circuit using this principle.

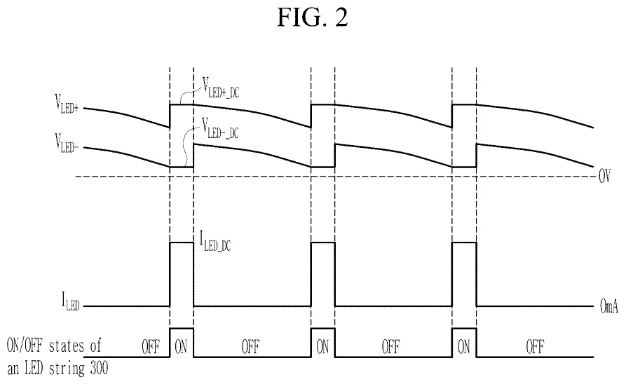

FIG. 2 illustrates a graph exemplifying LED driving voltages V_{LED+} and V_{LED-}, an LED driving current I_{LED}, and on/off states of an LED string 300. FIG. 2 assumes a case where the LED string 200 is driven in a dimming mode.

As shown in FIG. 2, the LED driving current I_{LED} may be a PWM signal. When the LED driving current I_{LED} is I_{LED_DC}, the LED string 200 may turn on. Then, when the LED driving current I_{LED} is 0 mA, the LED string 200 may turn off.

To turn on the LED string 200, the first LED driving voltage V_{LED+} may become a voltage V_{LED+_DC}, and the second LED driving voltage V_{LED-} may become a voltage V_{LED-_DC}. The LED string 200 may be turned on by a difference between the first LED driving voltage V_{LED+} and the second LED driving voltage V_{LED-}, specifically V_{LED+_DC}−V_{LED-_DC}.

Referring to FIG. 2, when the LED string 200 is turned off, the first LED driving voltage V_{LED+} may gradually decrease from the voltage V_{LED+_DC}. A capacitor may be used in the LED driving circuit 100 to output the first LED driving voltage V_{LED+}, and due to this capacitor, the first LED driving voltage V_{LED+} may gradually decrease from the voltage V_{LED+_DC}. Meanwhile, when the LED string 200 is turned off, the second LED driving voltage V_{LED-} may float and follow the first LED driving voltage V_{LED+}. That is, when the LED string 200 is turned off, the second LED driving voltage V_{LED-} may slightly increase from the voltage V_{LED-_DC} before gradually decreasing.

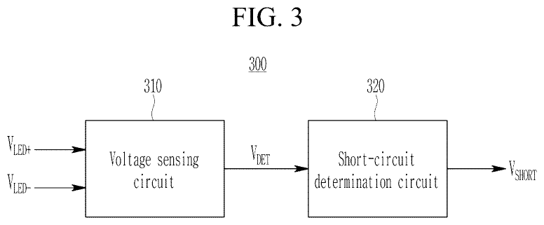

FIG. 3 illustrates a block diagram showing a simple internal configuration of an LED short detection circuit 300.

As shown in FIG. 3, the LED short detection circuit 300 may include a voltage sensing circuit 310 and a short-circuit determination circuit 320.

The voltage sensing circuit 310 may receive the first LED driving voltage V_{LED+} and the second LED driving voltage V_{LED-} as inputs. The voltage sensing circuit 310 may amplify a difference between values corresponding to the two input LED driving voltages V_{LED+} and V_{LED-}, and may output the amplified signal as a detection voltage V_{DET}.

The short-circuit determination circuit 320 may receive the detection voltage V_{DET} from the voltage sensing circuit (310), compare the detection voltage V_{DET} with a predetermined reference voltage to generate the short-circuit signal V_{SHORT}. As an example, if the detection voltage V_{DET} is lower than the reference voltage, the short-circuit signal V_{SHORT} may become high level. Then, if the detection voltage V_{DET} is higher than the reference voltage, the short-circuit signal V_{SHORT} may become low level.

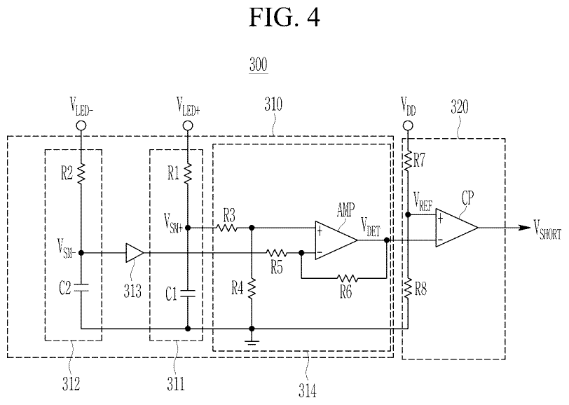

FIG. 4 illustrates a circuit diagram showing a detailed internal configuration of the LED short detection circuit 300.

As shown in FIG. 4, the voltage sensing circuit 310 may include a first smoothing circuit 311, a second smoothing circuit 312, a buffer 313, and a differential amplifier 314.

The first smoothing circuit 311 may include a resistor R1 and a capacitor C1. A first end of the resistor R1 may be applied with the first LED driving voltage V_{LED+}. That is, the first end of the resistor R1 may be connected to a first end of the LED string 200, and it may receive the first LED driving voltage V_{LED+}. The capacitor C1 may be connected between a second end of the resistor R1 and ground. The first smoothing circuit 311 has an RC smoothing circuit structure, and a first smoothing voltage V_{SM+} may be generated across the capacitor C1.

The second smoothing circuit 312 may include a resistor R2 and a capacitor C2. A first end of the resistor R2 may be applied with the second LED driving voltage V_{LED-}. That is, the first end of the resistor R2 may be connected to a second end of the LED string 200, and it may receive the second LED driving voltage V_{LED-}. The capacitor C2 may be connected between a second end of the resistor R2 and ground. The second smoothing circuit 312 has an RC smoothing circuit structure, and a second smoothing voltage V_{SM-} may be generated across the capacitor C2.

The buffer 313 may receive the second smoothing voltage V_{SM-} from the second smoothing circuit 312 and output the second smoothing voltage V_{SM-} to the differential amplifier 314. Herein, an input terminal of the buffer 313 may be connected to the second end of the resistor R2, and an output terminal of the buffer 313 may be connected to a resistor R5 of the differential amplifier 314.

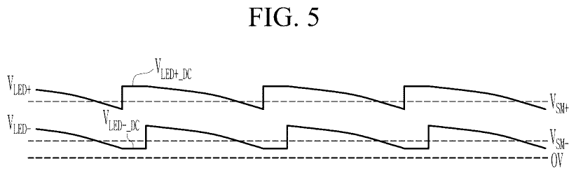

FIG. 5 illustrates a conceptual graph representing LED driving voltages V_{LED+} and V_{LED-} and smoothing voltages V_{SM+} and V_{SM-}.

As described in FIG. 2, when the LED driving current I_{LED} is a PWM signal, the LED driving voltages V_{LED+} and V_{LED-} may have fluctuating voltage values. That is, referring to FIG. 2 and FIG. 5, the first LED driving voltage V_{LED+} may have a variable voltage value, and the second LED driving voltage V_{LED-} may also have a variable voltage value.

The first smoothing circuit 311 may perform smoothing on the first LED driving voltage V_{LED+}, which has a fluctuating voltage value, to generate the first smoothing voltage V_{SM+}. That is, through the first smoothing circuit 311, an AC component in the first LED driving voltage V_{LED+} may be removed, and the first smoothing voltage V_{SM+} may be a DC voltage, as shown in FIG. 5. Herein, a value of the first smoothing voltage V_{SM+} may correspond to an average value of the first LED driving voltage V_{LED+}.

The second smoothing circuit 312 may perform smoothing on the second LED driving voltage V_{LED-} which has a fluctuating voltage value, to generate the second smoothing voltage V_{SM-}. That is, through the second smoothing circuit 312, an AC component in the second LED driving voltage V_{LED-} may be removed, and the second smoothing voltage V_{SM-} may be a DC voltage, as shown in FIG. 5. Herein, a value of the second smoothing voltage V_{SM-} may correspond to an average value of the second LED driving voltage V_{LED-}.

The differential amplifier 314 may receive the first smoothing voltage V_{SM+} from the first smoothing circuit 311 and the second smoothing voltage V_{SM-} from the second smoothing circuit 312. The differential amplifier 314 may amplify a difference between the first smoothing voltage V_{SM+} and the second smoothing voltage V_{SM-}, which are received, to output the detection voltage V_{DET}. Herein, the second smoothing voltage V_{SM-} may pass through the buffer 313 to be supplied to the differential amplifier (314). In the absence of the buffer 313, the second smoothing voltage V_{SM-} may be coupled with an output terminal of the differential amplifier 314, potentially being affected. The buffer 313 may prevent such an effect, and the second smoothing voltage V_{SM-} may pass through the buffer 313 to be supplied unchanged to the differential amplifier 314.

The differential amplifier 314 may include an amplifier AMP, a resistor R3, a resistor R4, a resistor R5, and a resistor R6.

The amplifier AMP may be an operational amplifier, and may have a non-inverting terminal (+), an inverting terminal (−), and an output terminal. The resistor R3 may be connected between a second terminal of the resistor R1 and the non-inverting terminal (+) of the amplifier AMP. The resistor R4 may be connected between the non-inverting terminal (+) of the amplifier AMP and ground. The resistor R5 may be connected between the output terminal of the buffer 313 and the inverting terminal (−) of the amplifier AMP. Then, the resistor R6 may be connected between the inverting terminal (−) and the output terminal of the amplifier AMP. A voltage at the output terminal of the amplifier AMP may serve as the detection voltage V_{DET}.

In the differential amplifier 314, a relationship among the first smoothing voltage V_{SM+}, the second smoothing voltage V_{SM-}, and the detection voltage V_{DET} may be as shown in Equation 2 below.

$${V}_{DET} = \frac{R 6}{R 5} ( {V}_{SM +} - {V}_{SM -} ) \qquad Equation 2$$

In Equation 2, it is assumed that R3=R5 and R4=R6.

Referring to Equation 2, the detection voltage V_{DET}, which is an output of the differential amplifier 314, may correspond to a product of a difference between the first smoothing voltage V_{SM+} and the second smoothing voltage V_{SM-} and a resistance ratio (R6/R5).

As shown in FIG. 4, the short-circuit determination circuit 320 may include a comparator CP, a resistor R7, and a resistor R8.

The comparator CP may have a non-inverting terminal (+), an inverting terminal (−), and an output terminal. A first end of resistor R7 may be applied with a power supply voltage VDD, and a second end of the resistor R7 may be connected to the non-inverting terminal (+) of the comparator CP. The resistor R8 may be connected between the non-inverting terminal (+) of the comparator CP and ground. The inverting terminal (−) of the comparator CP may receive the output voltage of the differential amplifier 314, that is, the detection voltage V_{DET}.

Herein, a reference voltage V_{REF} may be input to the non-inverting terminal (+) of the comparator CP, and the reference voltage V_{REF} may be determined based on voltage-resistance division, as shown in Equation 3 below.

$${V}_{REF} = \frac{R 8}{R 7 + R 8} {V}_{DD} \qquad Equation 3$$

The comparator CP may compare the reference voltage V_{REF} with the detection voltage V_{DET} to output the short-circuit signal V_{SHORT}. When the detection voltage V_{DET} is lower than the reference voltage V_{REF}, the comparator CP outputs the short-circuit signal V_{SHORT} with a high level. Then, when the detection voltage V_{DET} is higher than the reference voltage V_{REF}, the comparator CP may output the short-circuit signal V_{SHORT} with a low level. Herein, the reference voltage V_{REF} may be set to correspond to a degree to which a voltage between the two terminals of the LED string 200 drops when a short circuit occurs in the LED string 200.

As described above, if a short circuit occurs in at least one of the multiple LEDs LED₁ to LED_{N} included in the LED string 200, a voltage across opposite ends of the LED string 200 may decrease. That is, the difference value between the first LED driving voltage V_{LED+} and the second LED driving voltage V_{LED-} may decrease, and the difference value between the first smoothing voltage V_{SM+} and the second smoothing voltage V_{SM-} may also decrease. Accordingly, the detection voltage V_{DET}, which is the output voltage of the differential amplifier 314, may decrease, and the detection voltage V_{DET} may become lower than the reference voltage V_{REF}. When the detection voltage V_{DET} becomes lower than the reference voltage V_{REF}, the comparator CP outputs the short-circuit signal V_{SHORT} with a high level. Herein, the short-circuit signal V_{SHORT} with a high level may indicate that a short circuit has occurred in the LED string 200.

At least one embodiment of the embodiments attempts to provide an LED short detection circuit capable of detecting a short circuit in at least one LED among a plurality of LEDs.

According to at least one embodiment of the embodiments, it may be possible to detect a short circuit occurring in at least one LED included in an LED string.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A light-emitting diode (LED) short detection circuit, comprising:
a first smoothing circuit configured to receive a first LED driving voltage applied to a first end of an LED string and perform smoothing on the first LED driving voltage;
a second smoothing circuit configured to receive a second LED driving voltage applied to a second end of the LED string and perform smoothing on the second LED driving voltage;
an amplifier configured to amplify a difference between a first smoothing voltage output from the first smoothing circuit and a second smoothing voltage output from the second smoothing circuit to output a detection voltage; and
a short-circuit determination circuit configured to compare the detection voltage with a predetermined reference voltage to output a short-circuit signal indicating whether a short-circuit has occurred.

2. The LED short detection circuit of claim 1, further comprising
a buffer configured to receive the second smoothing voltage and output the second smoothing voltage to the amplifier.

3. The LED short detection circuit of claim 1, wherein
the first smoothing circuit comprises a first resistor having a first end connected to the first end of the LED string, and a first capacitor connected between a second end of the first resistor and ground, and
the second smoothing circuit comprises a second resistor having a first end connected to the second end of the LED string, and a second capacitor connected between a second end of the second resistor and ground.

4. The LED short detection circuit of claim 3, further comprising
a buffer configured to have an input terminal connected to the second end of the second resistor, and an output terminal outputting the second smoothing voltage to the amplifier.

5. The LED short detection circuit of claim 1, wherein
the short-circuit signal indicates a short circuit in response to the detection voltage being lower than the reference voltage.

6. The LED short detection circuit of claim 5, wherein
the short-circuit determination circuit comprises a comparator that receives each of the detection voltage and the reference voltage and outputs the short-circuit signal.

7. An LED system comprising:
an LED driving circuit configured to supply the first LED driving voltage and the second LED driving voltage; and
the LED short detection circuit of claim 1 configured to receive the first LED driving voltage and the second LED driving voltage.

8. A light-emitting diode (LED) system comprising:
an LED string configured to comprise a plurality of LEDs;
an LED driving circuit configured to supply a first LED driving voltage to a first end of the LED string and a second LED driving voltage to a second end of the LED string; and
an LED short detection circuit configured to receive the first LED driving voltage and the second LED driving voltage, and generate a short-circuit signal indicating whether a short-circuit has occurred in the LED string,
wherein the LED short detection circuit comprises:
a first smoothing circuit configured to perform smoothing on the first LED driving voltage to output a first smoothing voltage;
a second smoothing circuit configured to perform smoothing on the second LED driving voltage to output a second smoothing voltage;
an amplifier configured to amplify a difference between the first smoothing voltage and the second smoothing voltage to output a detection voltage; and
a short-circuit determination circuit configured to compare the detection voltage with a predetermined reference voltage to output a short-circuit signal.

9. The LED system of claim 8, wherein
the LED short detection circuit further comprises
a buffer configured to receive the second smoothing voltage and output the second smoothing voltage to the amplifier.

10. The LED system of claim 8, wherein
the first smoothing circuit is an RC smoothing circuit configured to generate the first smoothing voltage corresponding to an average value of the first LED driving voltage, and
the second smoothing circuit is an RC smoothing circuit configured to generate the second smoothing voltage corresponding to an average value of the second LED driving voltage.

11. The LED system of claim 8, wherein
the short-circuit signal indicates a short circuit in response to the detection voltage being lower than the reference voltage.

12. The LED system of claim 11, wherein
the short-circuit determination circuit comprises a comparator that receives each of the detection voltage and the reference voltage, and outputs the short-circuit signal.
